(19) United States
(12) Patent Application Publication
(10) Pub. No.: US 2012/0312692 A1
(43) Pub. Date: Dec. 13, 2012

(54) ALUMINUM POROUS BODY AND METHOD FOR PRODUCING THE SAME

(75) Inventors: Koutarou KIMURA, Osaka-shi (JP); Akihisa HOSOE, Osaka-shi (JP); Kazuki OKUNO, Osaka-shi (JP); Hajime OHTA, Osaka-shi (JP); Kengo GOTO, Osaka-shi (JP); Junichi NISHIMURA, Osaka-shi (JP)

(73) Assignee: SUMITOMO ELECTRIC INDUSTRIES, LTD., Osaka-shi (JP)

(21) Appl. No.: 13/528,061

(22) Filed: Jun. 20, 2012

Related U.S. Application Data
(63) Continuation of application No. PCT/JP2012/053218, filed on Feb. 13, 2012.

(30) Foreign Application Priority Data
Feb. 18, 2011 (JP) 2011-032785
May 18, 2011 (JP) 2011-111025

(51) Int. Cl. B32B 3/26; C25D 1/08

(52) U.S. Cl. 205/50; 205/75

(57) ABSTRACT

Provided is a method for readily removing urethane resin without causing oxidation of aluminum, from an aluminum structure in which an aluminum film is formed on the surface of a urethane resin porous body having a three-dimensional network structure: a method for producing an aluminum porous body, including forming an aluminum film having a purity of 99.9% by mass or more on a surface of a urethane resin porous body having a three-dimensional network structure to provide an aluminum structure including the urethane resin porous body and the aluminum film, and subjecting the aluminum structure to a heat treatment at 370° C. or more and less than 660° C. in the air to remove urethane resin and to provide an aluminum porous body.

### CROSS REFERENCES TO RELATED APPLICATIONS

This application is a Continuation of International Patent Application No. PCT/JP2012/053218, filed Feb. 13, 2012, which claims the benefit of Japanese Patent Application No. 2011-032785 filed in the Japan Patent Office on Feb. 18, 2011 and Japanese Patent Application No. 2011-111025 filed in the Japan Patent Office on May 18, 2011, the entire contents of these applications being incorporated herein by reference.

### TECHNICAL FIELD

The present invention relates to a method for producing an aluminum porous body in which the aluminum porous body is produced by removing urethane resin from an aluminum structure prepared by forming an aluminum film on the surface of a urethane resin porous body having a three-dimensional network structure; and the aluminum porous body.

### BACKGROUND ART

Porous metal bodies having three-dimensional network structures are being used in wide-ranging fields including various filters, catalyst carriers, and battery electrodes. For example, Celmet (registered trademark, manufactured by Sumitomo Electric Industries, Ltd.) composed of nickel is used as an electrode material for batteries including nickel-hydrogen batteries and nickel-cadmium batteries. Celmet is a porous metal body having continuous pores and has a feature of having a high porosity (90% or more) compared with other porous bodies such as metal nonwoven fabrics. Celmet is produced by forming a nickel layer on the surface of the skeleton of a resin porous body having continuous pores such as a urethane foam, then decomposing the foamed resin body through a heat treatment, and further subjecting the nickel to a reduction treatment. The nickel layer is formed by coating the surface of the skeleton of the foamed resin body with a carbon powder or the like to perform a conductive treatment, and then depositing nickel by electroplating.

As with nickel, aluminum is excellent in terms of conductive property, corrosion resistance property, lightweight, and the like. In the battery application, for example, an aluminum foil the surfaces of which are coated with an active material such as lithium cobalt oxide is used as a positive electrode of a lithium battery. To increase the capacity of the positive electrode, an aluminum porous body may be employed to provide a large surface area and may be filled with the active material. In this case, even when the electrode has a large thickness, the active material is available and a high availability ratio of the active material per unit area is achieved.

Patent Literature 1 describes a method for producing an aluminum porous body in which a three-dimensional network plastic substrate having inner continuous spaces is subjected to an aluminum vapor deposition process by an arc ion plating method to form a 2 to 20 μm aluminum metal layer.

According to this method, it is alleged that an aluminum porous body having a thickness of 2 to 20 μm can be produced. However, this method has, for example, the following problems: since the gas-phase method is employed, it is difficult to produce an aluminum porous body having a large area, and it is difficult to form a layer that is uniform to the inside depending on the thickness or porosity of the substrate; the rate of formation of the aluminum layer is low; the production cost becomes high due to, for example, expensive installations; and, when a thick film is formed, the film may suffer from cracking or falling of aluminum.

Patent Literature 2 describes a method for producing a porous metal body in which a film composed of a metal (such as copper) that can form a eutectic alloy with aluminum at a temperature equal to or lower than the melting point of aluminum is formed on the skeleton of a foamed resin body having a three-dimensional network structure; the foamed resin body is then coated with an aluminum paste and heated at a temperature of 550° C. or more and 750° C. or less in a non-oxidizing atmosphere to evaporate the organic constituent (foamed resin) and to sinter the aluminum powder.

However, since this method provides the layer that forms a eutectic alloy with aluminum, an aluminum layer having a high purity cannot be formed.

Another method may be employed in which a foamed resin body having a three-dimensional network structure is plated with aluminum. Although the process of electroplating with aluminum is known, aluminum has a high chemical affinity for oxygen and has a lower electric potential than hydrogen, and hence it is difficult to perform electroplating with plating baths containing aqueous solutions. Accordingly, the electroplating with aluminum has been studied in terms of plating baths containing non-aqueous solutions. For example, Patent Literature 3 discloses, as a technique of plating with aluminum for the purpose of, for example, suppressing oxidation of metal surfaces, an aluminum electroplating method in which a low melting composition prepared by blending and melting an onium halide and an aluminum halide is used as a plating bath and aluminum is deposited onto the cathode while the water content in the bath is maintained to be 2% by mass or less.

However, aluminum electroplating allows plating of metal surfaces only and there are no methods for electroplating the surfaces of resin molded bodies, in particular, the surfaces of resin porous bodies having three-dimensional network structures.

### CITATION LIST

### Patent Literature

PTL 1: Japanese Patent No. 3413662

PTL 2: Japanese Patent No. 3568052

PTL 3: Japanese Patent No. 3202072

### SUMMARY OF INVENTION

### Technical Problem

The inventors of the present invention thoroughly studied a method for subjecting the surface of a urethane resin porous body having a three-dimensional network structure to aluminum electroplating. As a result, the inventors found that the plating can be performed by subjecting a urethane resin porous body whose surface has been at least made conductive to aluminum plating in a molten salt bath. Thus, the inventors accomplished a method for producing an aluminum porous body. This production method provides an aluminum structure having a urethane resin porous body serving as the core of the skeleton. This composite composed of resin and metal may be used in applications of various filters, catalyst carriers, and the like. Alternatively, when a metal structure containing no resin is used in view of, for example, constraints on usage environments, the resin is removed to provide an aluminum porous body.

The removal of the resin may be performed by a desired process such as decomposition (dissolution) using an organic solvent, a molten salt, or supercritical water, or decomposition by heating. Here, although the processes such as thermal decomposition at a high temperature can be readily performed, it involves oxidation of aluminum. Unlike nickel and the like, it is difficult to reduce aluminum having been oxidized. For example, in the application of an electrode material for a battery or the like, oxidation of aluminum results in the loss of conductivity and hence aluminum cannot be used. Thus, the inventors of the present invention accomplished, as a method in which resin is removed without causing oxidation of aluminum, a method for producing an aluminum porous body in which, while an aluminum structure prepared by forming an aluminum film on the surface of a porous resin molded body is immersed in a molten salt and a negative potential is applied to the aluminum film, the aluminum structure is heated to a temperature less than the melting point of aluminum to thereby remove the porous resin molded body through thermal decomposition.

This method is excellent as a method in which resin is removed without causing oxidation of aluminum. However, the method employs a molten salt and can be improved in terms of steps and costs.

An object of the present invention is to provide a method in which urethane resin is readily removed without causing oxidation of aluminum, from an aluminum structure prepared by forming an aluminum film on the surface of a urethane resin porous body having a three-dimensional network structure.

### Solution to Problem

The inventors of the present invention have performed thorough studies on how to achieve the object. As a result, the inventors have found that, in an aluminum structure prepared by forming an aluminum film on the surface of a urethane resin porous body having a three-dimensional network structure, by making the purity of the aluminum film be 99.9% by mass or more, the aluminum film is not oxidized even when the resin is removed through thermal decomposition by heating at a high temperature in the air. Thus, the inventors have accomplished the present invention.

Specifically, the present invention relates to the following method for producing an aluminum porous body.

(1) A method for producing an aluminum porous body, including: forming an aluminum film having a purity of 99.9% by mass or more on a surface of a urethane resin porous body having a three-dimensional network structure to provide an aluminum structure including the urethane resin porous body and the aluminum film; and subjecting the aluminum structure to a heat treatment at 370° C. or more and less than 660° C. in the air to remove urethane resin and to provide an aluminum porous body.
(2) The method for producing an aluminum porous body according to (1), wherein the heat treatment is performed at 370° C. or more and 550° C. or less.
(3) The method for producing an aluminum porous body according to (1) or (2), wherein the urethane resin porous body is a polyurethane foam.
(4) The method for producing an aluminum porous body according to any one of (1) to (3), wherein the aluminum film is formed by electroplating in a molten salt bath.
(5) The method for producing an aluminum porous body according to (4), wherein, before the step of forming the aluminum film on the surface of the urethane resin porous body, a step of removing metal ions in molten salt by electrolysis is performed.
(6) An aluminum porous body having a three-dimensional network structure and an aluminum purity of 99.9% by mass or more.
(7) The aluminum porous body according to (6), wherein an aluminum oxide film having a thickness of less than 200 nm is present in an outer surface of an aluminum skeleton forming the three-dimensional network structure.
(8) The aluminum porous body according to (6) or (7), wherein metallic aluminum is present in an outermost surface of an aluminum skeleton forming the three-dimensional network structure.
(9) The aluminum porous body according to any one of (6) to (8), having a carbon content of less than 1 g/m².

### Advantageous Effects of Invention

According to the present invention, urethane resin is readily removed from an aluminum structure prepared by forming an aluminum film on the surface of a urethane resin porous body having a three-dimensional network structure, so that an aluminum porous body can be provided.

### BRIEF DESCRIPTION OF DRAWINGS

FIG. 1 is a graph illustrating the evaluation result of the thickness of an oxide film in an aluminum surface with a scanning X-ray photoelectron spectrometer when aluminum (A1050) having a purity of 99% by mass is subjected to a heat treatment in the air.

FIG. 2 is a graph illustrating the evaluation result of the thickness of an oxide film formed in an Al plating surface with a scanning X-ray photoelectron spectrometer when aluminum (A1050) on the surface of which the Al plating having a purity of 99.93% by mass is formed is subjected to a heat treatment in the air.

FIG. 3 illustrates the behavior of impurities when an aluminum porous body is used as a collector of a battery.

FIG. 4 is a flow chart illustrating steps for producing an aluminum structure according to the present invention.

FIG. 5 is a schematic sectional view illustrating steps for producing an aluminum structure according to the present invention.

FIG. 6 is a surface enlarged photograph illustrating the structure of a urethane resin porous body.

FIG. 7 illustrates an example of an aluminum continuous plating process using molten salt plating.

FIG. 8 is a schematic view illustrating a structural example in which an aluminum porous body is applied to a lithium battery.

FIG. 9 is a schematic view illustrating a structural example in which an aluminum porous body is applied to a capacitor.

FIG. 10 is a schematic sectional view illustrating a structural example in which an aluminum porous body is applied to a molten salt battery.

FIG. 11 illustrates a heat treatment profile for removing urethane resin through thermal decomposition in EXAMPLE.

### DESCRIPTION OF EMBODIMENTS

In the present invention, in an aluminum structure prepared by forming an aluminum film on the surface of a urethane resin porous body having a three-dimensional network structure, the urethane resin is subjected to a heat treatment in the air to remove the urethane resin through thermal decomposition.

The surface of aluminum is susceptible to oxidation and aluminum is generally covered with a natural oxide film (Al₂O₃ film). Heating of such aluminum having a natural oxide film in the air results in an increase in the thickness of the oxide film. When an aluminum porous body having a thick oxide film in the surface is used as a collector of a battery, it has poor collecting capability and cannot be used as a collector of a battery. When an aluminum porous body is used as a collector of a battery or the like, a step of welding a tab lead to the aluminum porous body is performed; in this step, weldability becomes poor when the aluminum porous body has a thick oxide film in the surface.

To thermally decompose a urethane resin, the urethane resin needs to be heated at a temperature of 370° C. or more. However, the thermal decomposition of a urethane resin at such a high temperature in the air results in the formation of a thick oxide film in the surface of an aluminum porous body. Accordingly, the removal of urethane through thermal decomposition in the air has not been performed.

However, the inventors of the present invention studied conditions under which the oxide film is not formed in aluminum and, as a result, the inventors have found that a low purity of aluminum results in the formation of a thick oxide film. Specifically, it has been found that, when aluminum containing impurities is heated in the air, oxidation proceeds from the impurities serving as starting points to form a thick oxide film; however, when aluminum having a purity of 99.9% by mass or more is heated at 370° C. or more in the air, the surface oxide layer does not become thick.

Accordingly, in the present invention, the purity of an aluminum film formed on the surface of a urethane resin porous body is made 99.9% by mass or more.

In the present invention, an aluminum film having a purity of 99.9% by mass or more needs to be formed on the surface of a urethane resin porous body. Such an aluminum film having a high purity can be formed on the surface of a urethane resin porous body by a process such as a vapor deposition process or a plating process.

Hereinafter, the following will be described: when aluminum having a purity of 99.9% by mass or more is subjected to a heat treatment in the air, the resultant oxide film is thinner than an oxide film formed in a case where aluminum having a purity of 99.0% by mass is subjected to the heat treatment in the air.

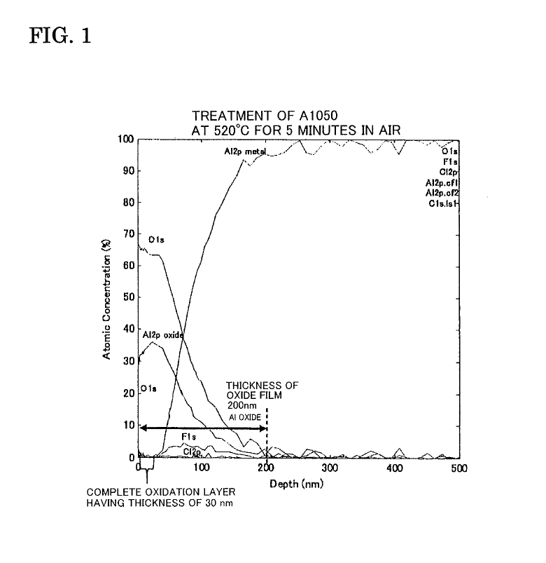

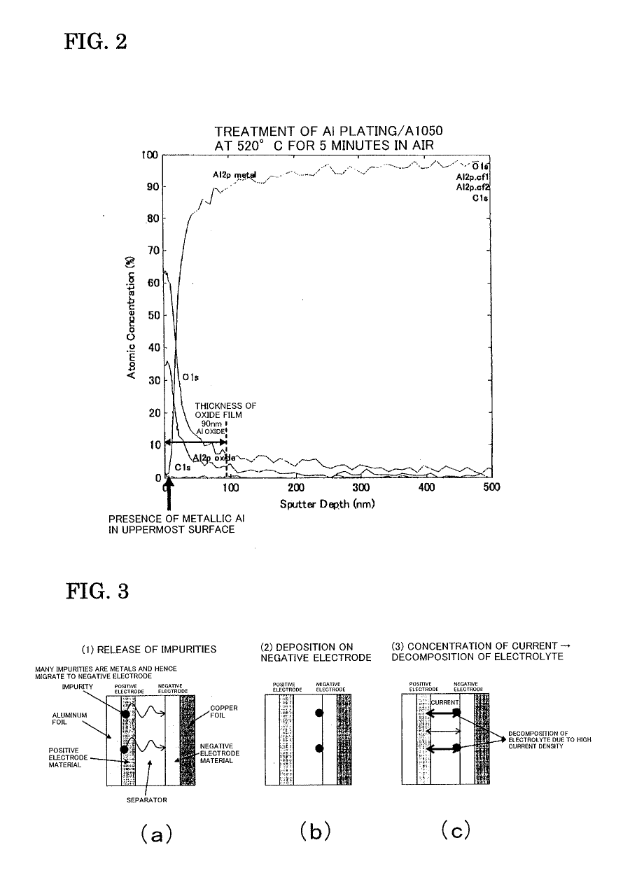

FIGS. 1 and 2 are graphs illustrating the results of analyses of the thicknesses of oxide films with a scanning X-ray photoelectron spectrometer. The oxide films were formed by a heat treatment at 520° C. in the air for 5 minutes, in the surface of aluminum (A1050) having a purity of 99% by mass in FIG. 1 and in the surface of an Al plating having a purity of 99.93% by mass on the surface of aluminum (A1050) in FIG. 2.

The analysis conditions were as follows.

Apparatus: ULVAC-PHI (QuanteraSXM)

X-ray source: monochrome-Al(Kα)

Beam condition: 100 μmφ/25W-15 kV

Transmission energy: 280 eV

Thickness: conversion in terms of SiO₂

The result in FIG. 1 indicates the formation of an oxide film having a thickness of 200 nm by the heat treatment of aluminum (A1050) having a purity of 99% by mass. In contrast, the result in FIG. 2 indicates the formation of an oxide film having a thickness of 90 nm by the heat treatment of aluminum having a purity of 99.93% by mass and the presence of metallic aluminum in the uppermost surface. Here, the “metallic aluminum” denotes aluminum in which the electronic state of aluminum atoms is found to be the metal state by X-ray photoelectron spectrometry. The results indicate that, by making aluminum have a purity of 99.9% by mass or more, even a heat treatment of the aluminum in the air does not result in the formation of a thick oxide film.

When an aluminum porous body having a low purity is used as a collector of a battery, the battery is expected to have a short life. This will be described on the basis of FIG. 3.

For example, as illustrated in FIG. 3(a), a battery is considered that includes a stack of a positive electrode constituted by an aluminum foil and a positive electrode material, a negative electrode constituted by a copper foil and a negative electrode material, and a separator. When an aluminum foil having a low purity is used, as illustrated in FIG. 3(a), metals serving as impurities in the aluminum are released to migrate to the negative electrode; and, as illustrated in FIG. 3(b), the metals are deposited on the negative electrode. Thus, as illustrated in FIG. 3(c), the current tends to flow through the portions where metal impurities are deposited. The current concentrates in the portions and the decomposition reaction of the electrolyte occurs. As a result, the electrolyte may be deteriorated. Such a problem can be overcome by use of an aluminum porous body having a purity of 99.9% by mass or more according to the present invention. The present invention has been accomplished on the basis of such findings.

Hereinafter, processes of producing an aluminum porous body will be described in detail. The processes will be described sometimes with reference to drawings on the basis of a representative example where an aluminum plating process is employed as a process of forming an aluminum film on the surface of a urethane resin porous body. The portions denoted by the same reference signs in the drawings referred to below are the same or corresponding portions. Note that the scope of the present invention is not limited to the description, is indicated by Claims, and embraces all the modifications within the meaning and range of equivalency of the Claims.

### (Steps for Producing Aluminum Structure)

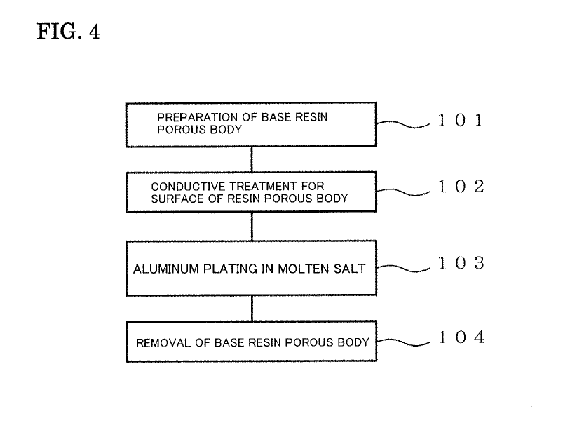

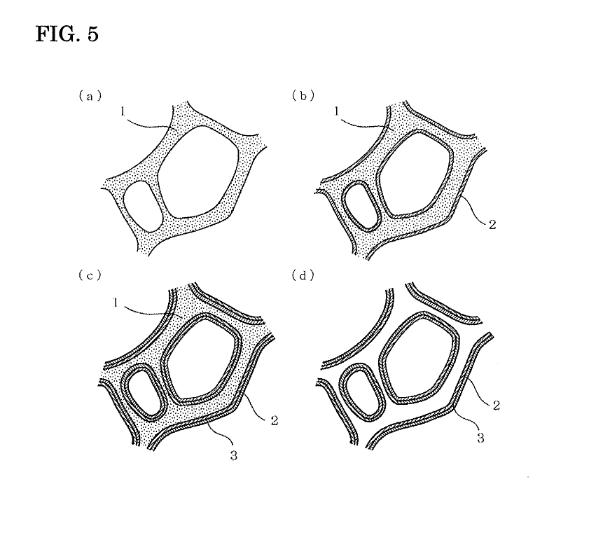

FIG. 4 is a flow chart illustrating steps for producing an aluminum structure. FIG. 5 corresponds to the flow chart and schematically illustrates the formation of an aluminum plating film with a resin porous body serving as a core member. The overall flow of the production steps will be described with reference to FIGS. 4 and 5. “Preparation of a base resin porous body” 101 is first performed. FIG. 5(a) is an enlarged schematic view illustrating an enlarged surface of the resin porous body having continuous pores, the resin porous body serving as an example of the base resin porous body. The pores are formed in a resin porous body 1 serving as a skeleton. “Conductive treatment for the surface of the resin porous body” 102 is then performed. As a result of this step, as illustrated in FIG. 5(b), a conductive layer 2 that is thin and composed of a conductive material is formed on the surface of the resin porous body 1.

“Aluminum plating in a molten salt” 103 is then performed to form an aluminum plating layer 3 on the surface of the resin porous body having the conductive layer (FIG. 5(c)). As a result, an aluminum structure in which the aluminum plating layer 3 is formed on the surface of the base resin porous body serving as a base is obtained. Regarding the base resin porous body, “removal of the base resin porous body” 104 is performed.

By eliminating the resin porous body 1 by decomposition or the like, an aluminum structure (porous body) constituted by the remaining metal layer can be obtained (FIG. 5(d)). Hereinafter, the steps will be sequentially described.

### (Preparation of Resin Porous Body)

A resin porous body having a three-dimensional network structure and continuous pores is prepared. The resin porous body is formed of a foamed resin body composed of polyurethane. Although the “foamed resin body” is mentioned, a resin porous body having any form can be selected as long as it has continuous pores. For example, a resin porous body that has a form similar to nonwoven fabric and is prepared by intertwining resin fibers may be used instead of the foamed resin body. The foamed resin body preferably has a porosity of 80% to 98% and a pore diameter of 50 to 500 μm. A urethane foam has a high porosity, high uniformity of pores, a small pore diameter, continuity of pores, and an excellent thermal decomposition property, and is easily available.

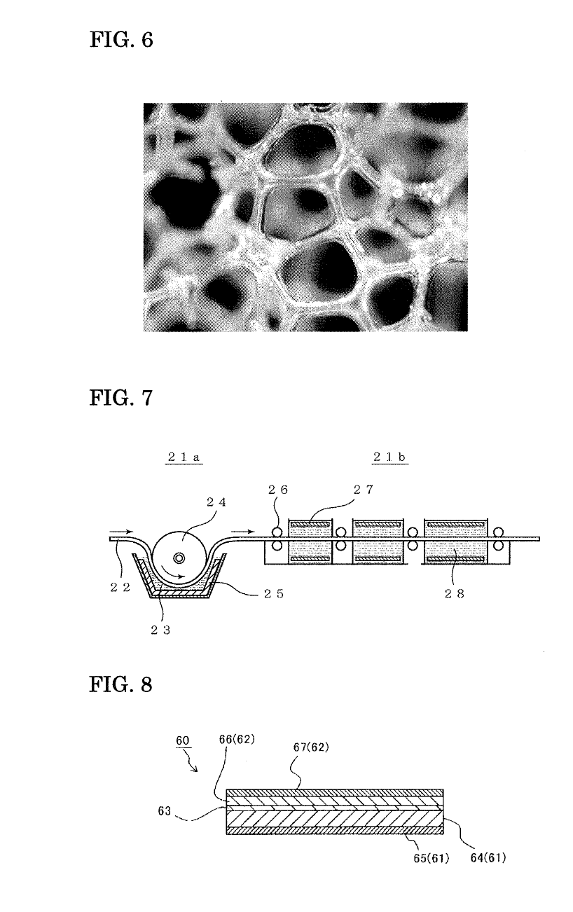

Since a urethane resin porous body often contains residual materials including a foaming agent and an unreacted monomer that are used in the production of the foam, it is preferably subjected to a washing treatment in view of the subsequent steps. A urethane resin porous body having been subjected to a washing treatment as a pretreatment is illustrated in FIG. 6. In the resin porous body, the skeleton forms a three-dimensional network to thereby constitute pores that are continuous through the resin porous body. The skeleton of a urethane resin porous body has a substantially triangular shape in a cross section perpendicular to the direction in which the urethane resin porous body extends. The porosity is defined by the following equation.

Porosity=(1−(Mass of porous material [g]/(Volume of porous material [cm³]×Material density)))×100 [%]

The pore diameter is determined in the following manner. The surface of the resin porous body is magnified with, for example, a photomicrograph. The number of pores per inch (25.4 mm) is counted as cell number and the pore diameter is calculated as an average value: Average pore diameter=25.4 mm/cell number.

### (Conductive Treatment for Surface of Resin Porous Body)

The surface of the resin foam is subjected to a conductive treatment before electroplating is performed. The treatment is not particularly limited as long as it allows formation of a conductive layer on the surface of the resin porous body. A desired treatment can be selected from, for example, non-electrolytic plating with a conductive metal such as nickel, vapor deposition of aluminum or the like, sputtering of aluminum or the like, and coating with a conductive coating material containing conductive particles composed of carbon or the like.

### (Formation of Aluminum Film: Molten Salt Plating)

Electroplating is then performed in a molten salt to form an aluminum plating film on the surface of the resin porous body.

By performing aluminum plating in a molten salt bath, a thick aluminum film can be uniformly formed on the surface of a complex skeleton structure, in particular, a resin porous body having a three-dimensional network structure.

In a molten salt, a direct current is applied between a negative electrode that is the resin porous body whose surface has been made conductive and a positive electrode that is aluminum.

The molten salt may be an organic molten salt that is a eutectic salt between an organohalide and an aluminum halide, or an inorganic molten salt that is a eutectic salt between a halide of an alkali metal and an aluminum halide. Use of a bath of an organic molten salt that melts at a relatively low temperature is preferred because the resin porous body serving as the base can be plated without being decomposed. Examples of the organohalide include imidazolium salts and pyridinium salts. Specifically, 1-ethyl-3-methylimidazolium chloride (EMIC) and butylpyridinium chloride (BPC) are preferred.

Since entry of water or oxygen into the molten salt results in deterioration of the molten salt, plating is preferably performed in an atmosphere of an inert gas such as nitrogen or argon and in a sealed environment.

The molten salt bath preferably contains nitrogen. In particular, an imidazolium-salt bath is preferably used. When a salt that melts at a high temperature is used as the molten salt, dissolution or decomposition of the resin in the molten salt occurs before the plating layer is grown and hence the plating layer cannot be formed on the surface of the resin porous body. An imidazolium-salt bath can be used even at a relatively low temperature without affecting the resin. The imidazolium salts are preferably salts including an imidazolium cation having alkyl groups at the 1 and 3 positions. In particular, a molten salt mixture of aluminum chloride and 1-ethyl-3-methylimidazolium chloride (AlCl₃-EMIC) is most preferably used because it is highly stable and is less likely to decompose. For example, a urethane resin foam or a melamine resin foam can be plated with a molten salt bath at a temperature of 10° C. to 65° C., preferably 25° C. to 60° C. The lower the temperature, the narrower the current density range that allows plating becomes. Thus, it becomes difficult to plate the entire surface of the porous body. A high temperature of more than 65° C. tends to result in a problem that the shape of the base resin is degraded.

To make the purity of the aluminum film be 99.9% by mass or more formed on the surface of a resin porous body, the purity of aluminum serving as a positive electrode material needs to be made 99.9% by mass or more, preferably 99.99% by mass or more; in addition, the amount of impurities such as Fe and Cu contained in the molten salt bath needs to be minimized.

To reduce the amount of impurities such as Fe and Cu that are unavoidably contained in the molten salt bath, there is a preferred process in which, before the step of forming an aluminum plating film on the surface of a resin porous body, electrolysis (dummy plating) using a positive electrode and a negative electrode (dummy negative electrode) that are composed of aluminum is performed to deposit ions of Fe, Cu, and the like in the molten salt bath onto the dummy negative electrode, and electrolysis is then performed in which the resin porous body having been subjected to the conductive treatment is used as the negative electrode instead of the dummy negative electrode.

In molten salt aluminum plating for a metal surface, addition of an additive such as xylene, benzene, toluene, or 1,10-phenanthroline to AlCl₃-EMIC for the purpose of enhancing the smoothness of the plating surface has been reported. The inventors of the present invention have found that, in particular, in the case of subjecting a resin porous body having a three-dimensional network structure to aluminum plating, addition of 1,10-phenanthroline provides special features to the formation of an aluminum porous body: specifically, the first feature is that the smoothness of the plating film is enhanced and the aluminum skeleton forming the porous body is less likely to break; and the second feature is that uniform plating can be achieved such that the difference in plating thickness is small between the surface portion and the internal portion of the porous body.

As a result of the two features that the skeleton is less likely to break and the plating thickness is uniform between the internal portion and the external portion, for example, in the case where a produced aluminum porous body is pressed, the entire skeleton is less likely to break and a porous body that has been uniformly pressed can be provided. When an aluminum porous body is used as an electrode material for a battery or the like, the electrode is filled with an electrode active material and pressed to increase the density. Since the skeleton tends to break during the filling step of the active material and the pressing, the aluminum porous body is very useful in such applications.

Accordingly, addition of an organic solvent to a molten salt bath is preferred. In particular, 1,10-phenanthroline is preferably used. The amount of addition to the plating bath is preferably 0.2 to 7 g/L. When the amount is 0.2 g/L or less, the plating has insufficient smoothness and is brittle, and the feature of small difference in thickness between the surface layer and the internal portion is less likely to be achieved. When the amount is 7 g/L or more, the plating efficiency becomes low and it becomes difficult to achieve a predetermined plating thickness.

FIG. 7 schematically illustrates the configuration of an apparatus for continuously subjecting the strip-shaped resin to an aluminum plating process: a strip-shaped resin 22 the surfaces of which have been made conductive is transported from the left to the right of FIG. 7. A first plating container 21a is constituted by a cylindrical electrode 24, a positive electrode 25 disposed on the inner surfaces of the container and composed of aluminum, and a plating bath 23. The strip-shaped resin 22 is made to pass through the plating bath 23 along the cylindrical electrode 24 and, as a result, current tends to uniformly flow through the entirety of the resin porous body and a uniform plating can be formed. A plating container 21b is used for making the plating thicker and more uniformly and is constituted such that plating is repeated in a plurality of containers. The strip-shaped resin 22 the surfaces of which have been made conductive is sequentially transported with electrode rollers 26 that function as both a transport roller and a feed negative electrode disposed on the outside of the container; thus, the strip-shaped resin 22 is made to pass through plating baths 28 so as to be plated. In each of the plurality of containers, positive electrodes 27 composed of aluminum are disposed so as to face both surfaces of the resin porous body, with the plating bath 28 between the positive electrodes 27 and the surfaces. Thus, both surfaces of the resin porous body can be more uniformly plated. The aluminum porous body obtained by the plating is subjected to nitrogen blow to sufficiently remove the plating solution, and then to water washing to provide an aluminum porous body.

A bath of a molten salt that is an inorganic salt may be used under conditions such that, for example, the resin is not dissolved. Typically, the bath of an inorganic salt contains a two-component system salt of AlCl₃-XCl (X: alkali metal) or a multi-component system salt. Although such inorganic-salt baths generally have a higher melting point than organic-salt baths such as imidazolium-salt baths, constraints on environmental conditions in terms of water content, oxygen, and the like are less strict and can be practically used at low cost in total. When the resin is a melamine resin foam, which can be used at a higher temperature than urethane resin foams, an inorganic-salt bath at 60° C. to 150° C. is used.

As a result of the above-described steps, an aluminum structure having a resin porous body serving as the core of the skeleton is provided. This composite composed of resin and metal may be used in applications of various filters, catalyst carriers, and the like. Alternatively, when a metal structural body containing no resin is used in view of, for example, constraints on usage environments, the resin is removed. According to the present invention, the resin is removed by thermal decomposition in the air as described below.

### (Removal of Resin Through Thermal Decomposition)

To thermally decompose a urethane resin, the urethane resin needs to be treated at a temperature of 370° C. or more. However, the treatment is performed without melting aluminum, and hence needs to be performed at a temperature less than the melting point of aluminum (660° C.). When the urethane resin is treated at a high temperature that is less than the melting point of aluminum (660° C.), for example, 600° C., it can be thermally decomposed in a shorter period of time and the degree of oxidation becomes lower. A decrease in the treatment temperature enhances the control accuracy of the temperature and suppression of oxidation of aluminum can be achieved with more stability. A preferred temperature range is 370° C. or more and 550° C. or less. When the temperature is 500° C. or more, carbon (soot) generated from the thermal decomposition of the urethane resin reacts with oxygen in the air to form CO₂. Thus, carbon is removed.

An aluminum porous body according to the present invention obtained in the above-described manner (hereafter referred to as “present aluminum porous body”) may be used for various applications. Hereinafter, preferred applications of the present aluminum porous body will be described.

### Collector for Battery (Lithium Battery (LIB), Capacitor, or Molten Salt Battery)

The present aluminum porous body has a three-dimensional porous structure (high specific surface area) in which a large amount of a battery material can be stored. Thus, a thick high-capacity electrode can be formed, which results in a decrease in the electrode area and a decrease in the cost. In addition, excess amounts of a binder and a conductive aid can be reduced and the capacity of the battery can be increased.

The present aluminum porous body has a good contact with the battery material and the power of the battery can be increased; in addition, falling of the battery material is suppressed and the life of the battery or a capacitor can be increased. Thus, the present aluminum porous body can be used for electrode collectors for LIBs, capacitors, molten salt batteries, and the like.

### Catalyst Carrier (Industrial Deodorant Catalyst or Catalyst for Sensor)

The present aluminum porous body has a three-dimensional porous structure (high specific surface area). As a result, the catalyst carrier area and the contact area with gas are increased and hence the catalyst carrier effect is enhanced. Accordingly, the present aluminum porous body can be used for catalyst carriers for industrial deodorant catalysts, catalysts for sensors, and the like.

### Heating Equipment (Vaporization or Atomization of Kerosene)

The present aluminum porous body has a three-dimensional porous structure (high specific surface area). When the present aluminum porous body is used for a heater, kerosene can be efficiently heated and vaporized. Accordingly, the present aluminum porous body can be used for heating equipment such as vaporization units and atomization units for kerosene.

### Various Filters (Oil-Mist Collector or Grease Filter)

Since the present aluminum porous body has a three-dimensional porous structure (high specific surface area), it has a large contact area with oil mist and grease and can efficiently collect oil and grease. Accordingly, the present aluminum porous body can be used for various filters such as oil-mist collectors and grease filters.

### Filter for Radiation-Tainted Water

Since aluminum has a property of shielding radiation, it is used as a material for suppressing radiation leak. At present, there is an issue of decontamination of radiation-tainted water generated from nuclear power plants. Since aluminum foils used as materials for suppressing radiation leak do not let water pass therethrough, they cannot be used for decontamination of radiation-tainted water. In contrast, since the present aluminum porous body has a three-dimensional porous structure (high specific surface area), it lets water pass therethrough and can be used as a decontamination filter for radiation-tainted water. By forming a double-structured film constituted by Poreflon (registered trademark, polytetrafluoroethylene (PTFE) porous body) and the present aluminum porous body, filtration of impurities can be enhanced.

Silencer (Sound Deadening for Engine and air Equipment or Reduction of Wind Roar such as Pantagraph Sound Absorption)

Since the present aluminum porous body has a three-dimensional porous structure (high specific surface area), it can considerably absorb sound. In addition, the present aluminum porous body is composed of aluminum and is lightweight, it can be used for silencers for engines and air equipment and reduction of wind roar, for example, as a sound absorption material for pantagraphs.

### Electromagnetic-Wave Shielding (Shielding Rooms or Various Shields)

Since the present aluminum porous body has a continuous-pore structure (high air permeability), it has higher air permeability than sheet-shaped electromagnetic shielding materials. In addition, since the pore diameter can be freely selected, the present aluminum porous body can be formed so as to correspond to various frequency bands and hence they can be used for electromagnetic-wave shielding, for example, shielding rooms and various electromagnetic-wave shields.

### Heat Dissipation or Heat Exchange (Heat Exchanger or Heatsink)

Since the present aluminum porous body has a three-dimensional porous structure (high specific surface area), is composed of aluminum, and has a high thermal conductivity, it considerably dissipates heat. Accordingly, the present aluminum porous body can be used for heat dissipation or heat exchange, for example, as a heat exchanger or a heatsink.

Fuel cell

At present, carbon paper is mainly used for gas-diffusion/collectors and separators of polymer electrolyte fuel cells. However, it has problems that the material cost is high and formation of complex channels is required, which results in high production cost. In contrast, since the present aluminum porous body has features of a three-dimensional porous structure, a low resistance, and a passivation film present in the surface, it can be used, without formation of complex channels, as a gas-diffusion layer/collector and a separator at a high electric potential and in an acidic atmosphere in a fuel cell, which results in cost reduction. Accordingly, the present aluminum porous body can be used for fuel cells, for example, as gas-diffusion layer/collectors and separators of polymer electrolyte fuel cells.

### Base Material for Hydroponic Culture

In hydroponic culture, to promote growth, a method of heating the base material by far infrared rays is employed. At present, for example, rock wool is mainly used as a base material for hydroponic culture. However, rock wool has a poor thermal conductivity and exhibits a poor heat exchange efficiency. In contrast, the present aluminum porous body has a three-dimensional porous structure (high specific surface area) and can be used as a base material for hydroponic culture; in addition, since it is composed of aluminum and exhibits a high thermal conductivity, it allows efficient heating of the base material and hence can be used as a base material for hydroponic culture. In addition, when the present aluminum porous body is used, the base material can be heated by an induction heating method. Accordingly, the present aluminum porous body can be used as a base material for hydroponic culture that allows efficient heating of the base material, compared with the far infrared ray method.

### Building Materials

Conventionally, aluminum porous bodies having closed pores are sometimes used as building materials for the purpose of decreasing the weight of building materials. Since the present aluminum porous body has a three-dimensional porous structure (high porosity), a further decrease in the weight can be achieved, compared with closed-pore aluminum porous bodies. In addition, since the present aluminum porous body has continuous pores, the spaces can be filled with another material such as a resin. Accordingly, combination of the present aluminum porous body with materials having functions such as thermal insulating properties, sound insulating properties, and humidity conditioning properties can provide composite materials having functions that cannot be provided by conventional closed-pore aluminum porous bodies.

### Electromagnetic Induction Heating

To prepare tasty dishes, it is said that earthen pots are preferably selected as cooking devices. Meanwhile, induction heating (IH) allows fine control of heating. To utilize the features of earthen pots and IH, there has been a demand for earthen pots that can be heated by IH. Although methods have been proposed in which, for example, a magnetic material is disposed at the bottom of an earthen pot or a special soil is used, sufficient thermal conduction is not achieved by these methods and the feature of IH is not fully utilized. In contrast, when an earthen pot is formed by filling the present aluminum porous body serving as a core material with soil and sintering the resultant material in an inert gas atmosphere, the earthen pot can be uniformly heated because the aluminum porous body serving as the core material generates heat. Although both a nickel porous body and an aluminum porous body are effectively used, in view of achieving lightweight, the present aluminum porous body is preferred.

Various applications of the present aluminum porous body have been described so far. Hereinafter, among the above-described applications, the applications to a lithium battery, a capacitor, and a molten salt battery will be described in detail.

### (Lithium Battery)

Hereinafter, a battery and an electrode material for a battery in which an aluminum porous body is used will be described. For example, in the case of the positive electrode of a lithium battery, examples of an active material include lithium cobalt oxide (LiCoO₂), lithium manganate (LiMn₂O₄), and lithium nickel oxide (LiNiO₂). The active material is used in conjunction with a conductive aid and a binder. Conventionally, a positive electrode material for a lithium battery is formed by coating the surfaces of an aluminum foil with the active material. To increase the battery capacity per unit area, the coating thickness of the active material is made large. To effectively use the active material, the active material needs to be in electrical contact with the aluminum foil, and hence the active material is used as a mixture with a conductive aid. In contrast, an aluminum porous body according to the present invention has a high porosity and a large surface area per unit area. Accordingly, even when a thin layer of the active material is formed on the surface of the porous body, the active material can be effectively used. Thus, the capacity of the battery can be increased and the amount of the conductive aid mixed can be decreased. In the lithium battery, the above-described positive electrode material is used for the positive electrode while the negative electrode is formed of, for example, graphite, lithium titanate (Li₄Ti₅O₁₂), an alloy containing Si or the like, or lithium metal. The electrolyte may be an organic electrolyte or a solid electrolyte. Such a lithium battery can have a higher capacity in spite of a small electrode area and hence can have a higher battery energy density than conventional lithium batteries.

### (Electrode for Lithium Battery)

Electrolytes used for lithium batteries are nonaqueous electrolytes and solid electrolytes.

FIG. 8 is a longitudinal sectional view of an all-solid-state lithium battery employing a solid electrolyte. This all-solid-state lithium battery 60 includes a positive electrode 61, a negative electrode 62, and a solid electrolyte layer (SE layer) 63 disposed between the electrodes. The positive electrode 61 includes a positive electrode layer (positive electrode body) 64 and a positive electrode collector 65. The negative electrode 62 includes a negative electrode layer 66 and a negative electrode collector 67.

An electrolyte other than the solid electrolyte may be a nonaqueous electrolyte described below. In this case, a separator (for example, a porous polymer film) is disposed between the electrodes and the nonaqueous electrolyte is impregnated into the electrodes and the separator.

### (Active Material for Filling Aluminum Porous Body)

In the case where an aluminum porous body is used for the positive electrode of a lithium battery, the active material may be a material that allows intercalation and deintercalation of lithium, and the aluminum porous body is filled with the material to provide an electrode suitable for a lithium secondary battery. Examples of a material of the positive electrode active material include lithium cobalt oxide (LiCoO₂), lithium nickel oxide (LiNiO₂), lithium cobalt nickel oxide (LiCo_{0.3}Ni_{0.7}O₂), lithium manganate (LiMn₂O₄), lithium titanate (Li₄Ti₅O₁₂), lithium manganese oxide compounds (LiM_{y}Mn_{2-y}O₄); M=Cr, Co, Ni), and lithium composite oxides. The active material is used in conjunction with a conductive aid and a binder. For example, there are transition metal oxides such as olivine compounds including conventional lithium iron phosphate and its compound (LiFePO₄ and LiFe_{0.5}Mn_{0.5}PO₄). The transition metal elements in these materials may be partially replaced by another transition metal element.

Other examples of a material of the positive electrode active material include sulfide-base chalcogenide compounds such as TiS₂, V₂S₃, FeS, FeS₂, and LiMSx (M represents a transition metal element such as Mo, Ti, Cu, Ni or Fe, or Sb, Sn, or Pb), and lithium metals containing as the skeleton a metal oxide such as TiO₂, Cr₃O₈, V₂O₅, or MnO₂. The above-described lithium titanate (Li₄Ti₅O₁₂) may be used as the negative electrode active material.

(Electrolyte used for Lithium Battery)

Examples of the nonaqueous electrolytes include polar aprotic organic solvents: specifically, ethylene carbonate, diethyl carbonate, dimethyl carbonate, propylene carbonate, γ-butyrolactone, and sulfolane. Examples of supporting electrolytes include lithium tetrafluoroborate, lithium hexafluorophosphate, and imide salts.

### (Solid Electrolyte for Filling Aluminum Porous Body)

In addition to the active material, a solid electrolyte may be added for the filling. By filling the aluminum porous body with the active material and the solid electrolyte, an electrode suitable for an all-solid-state lithium battery can be provided. The percentage of the active material in the material for filling the aluminum porous body is preferably 50% by mass or more, more preferably 70% by mass or more, in view of ensuring discharge capacity.

The solid electrolyte is preferably a sulfide-base solid electrolyte having high lithium ion conductivity. Examples of such a sulfide-base solid electrolyte include sulfide-base solid electrolytes containing lithium, phosphorus, and sulfur. The sulfide-base solid electrolyte may further contain an element such as O, Al, B, Si, or Ge.

The sulfide-base solid electrolyte can be obtained by a publicly known method: for example, lithium sulfide (Li₂S) and phosphorus pentasulfide (P₂S₅) serving as starting materials are prepared; mixing Li₂S and P₂S₅ in a molar ratio of about 50:50 to about 80:20; and melting and rapidly quenching the mixture (rapid quenching) or mechanically milling the mixture (mechanical milling).

The sulfide-base solid electrolyte obtained by this method is amorphous. Although the sulfide-base solid electrolyte may be used in this amorphous state, it may be heated to form a crystalline sulfide-base solid electrolyte. As a result of crystallization, an increase in the lithium ion conductivity can be expected.

(Filling Aluminum Porous Body with Active Material)

Filling with the active material (active material and solid electrolyte) may be performed by a publicly known method such as a immersion filling method or a coating method. Examples of the coating method include roll coating, applicator coating, electrostatic coating, powder coating, spray coating, spray coater coating, bar coater coating, roll coater coating, dipping coater coating, doctor blade coating, wire bar coating, knife coater coating, blade coating, and screen coating.

When the active material (active material and solid electrolyte) is used for filling, for example, it is mixed with a conductive aid and a binder as needed, and the resultant mixture is mixed with an organic solvent to prepare a slurry mixture of positive electrode materials. The aluminum porous body is filled with the slurry mixture by the above-described method. The filling with the active material (active material and solid electrolyte) is preferably performed in an inert gas atmosphere to suppress oxidation of the aluminum porous body. Examples of the conductive aid include carbon blacks such as acetylene black (AB) and Ketjen Black (KB). Examples of the binder include polyvinylidene fluoride (PVDF) and polytetrafluoroethylene (PTFE).

The organic solvent used in the preparation of the slurry mixture of positive electrode materials can be appropriately selected as long as it does not adversely affect materials (that is, an active material, a conductive aid, a binder, and optionally, a solid electrolyte) used for filling the aluminum porous body. Examples of the organic solvent include n-hexane, cyclohexane, heptane, toluene, xylene, trimethylbenzene, dimethyl carbonate, diethyl carbonate, ethyl methyl carbonate, propylene carbonate, ethylene carbonate, butylene carbonate, vinylene carbonate, vinyl ethylene carbonate, tetrahydrofuran, 1,4-dioxane, 1,3-dioxolane, ethylene glycol, and N-methyl-2-pyrrolidone.

Conventionally, a positive electrode material for an ion battery is formed by coating the surfaces of an aluminum foil with the active material. To increase the battery capacity per unit area, the coating thickness of the active material is made large. To effectively use the active material, the active material needs to be in electrical contact with the aluminum foil, and hence the active material is used as a mixture with a conductive aid. In contrast, the aluminum porous body has a high porosity and a large surface area per unit area. Accordingly, even when a thin layer of the active material is formed on the surface of the porous body, the active material can be effectively used. Thus, the capacity of the battery can be increased and the amount of the conductive aid mixed can be decreased. In a lithium battery, the above-described positive electrode material is used for the positive electrode; the negative electrode is formed of graphite; and the electrolyte is an organic electrolyte. Such a lithium battery can have a higher capacity in spite of a small electrode area and hence can have a higher battery energy density than conventional lithium batteries.

### (Electrode for Capacitor)

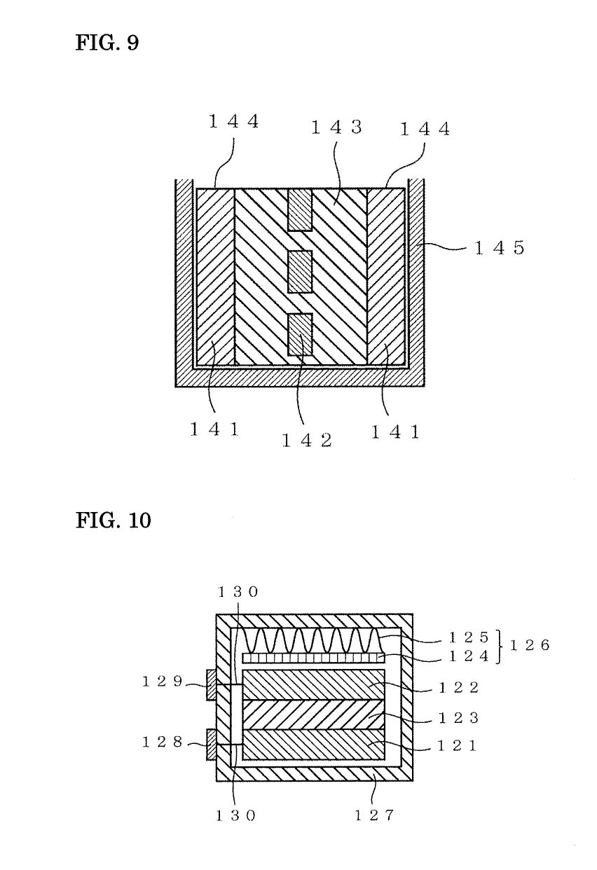

FIG. 9 is a schematic sectional view of a capacitor serving as an example, the capacitor including electrode materials for a capacitor. In an organic electrolyte 143 separated with a separator 142, electrode materials that are aluminum porous bodies carrying electrode active materials are disposed as polarizable electrodes 141. The polarizable electrodes 141 are connected to lead wires 144. The entire structure is contained in a case 145. By using aluminum porous bodies as collectors, the collectors have a larger surface area; even when activated carbon serving as an active material is applied in a small thickness, a capacitor having a high power and a high capacitance can be obtained.

To produce an electrode for a capacitor, activated carbon is used as an active material in a collector. Activated carbon is used in conjunction with a conductive aid and a binder. Examples of the conductive aid include graphite and carbon nanotubes. Examples of the binder include polytetrafluoroethylene (PTFE) and styrene-butadiene rubber.

An activated carbon paste is used for filling. To increase the capacitance of the capacitor, the higher the content of activated carbon serving as a main component, the more preferable it is. The content of activated carbon in the composition after drying (after removal of the solvent) is preferably 90% by mass or more. Although the conductive aid and the binder are necessary, they cause a decrease in the capacitance. In addition, the binder can cause an increase in the internal resistance. Accordingly, the contents of the conductive aid and the binder are preferably minimized. The content of the conductive aid is preferably 10% by mass or less. The content of the binder is preferably 10% by mass or less.

The larger the surface area of activated carbon, the higher the capacitance of the capacitor becomes. Accordingly, the specific surface area of activated carbon is preferably 2000 m²/g or more. Examples of the conductive aid include Ketjen Black, acetylene black, carbon fibers, and composite materials of the foregoing. Examples of the binder include polyvinylidene fluoride, polytetrafluoroethylene, polyvinyl alcohol, carboxymethyl cellulose, and xanthane gum. The solvent may be appropriately selected from water and organic solvents in accordance with the type of the binder. For organic solvents, N-methyl-2-pyrrolidone is often used. When water is used as the solvent, a surfactant may be used to enhance the filling properties.

Electrode materials containing activated carbon as a main component are mixed and stirred to provide an activated carbon paste. The collector is filled with the activated carbon paste, dried, and optionally subjected to thickness adjustment with a roller press or the like, to provide an electrode for a capacitor.

### (Production of Capacitor)

Two electrode sheets were prepared by punching out the thus-obtained electrode so as to have an appropriate size. The electrode sheets were placed so as to face each other with a separator therebetween. This structure is contained in a cell case with necessary spacers so that it is impregnated with an electrolyte. Finally, the opening of the case is sealed with a lid through an insulation gasket to produce a capacitor containing a nonaqueous electrolyte. When a nonaqueous material is used, to minimize the water content in the capacitor, the capacitor is produced in an environment having a low water content and the sealing is performed in an environment having a reduced pressure. The capacitor is not particularly limited as long as a collector and an electrode according to the present invention are used; and the capacitor may be produced by another method.

The negative electrode is not particularly limited and may be a conventional electrode for a negative electrode. However, since a conventional electrode employing an aluminum foil as a collector has a low capacitance, an electrode prepared by filling a porous body such as the above-described nickel foam with an active material is preferably used.

Although the electrolyte may be an aqueous electrolyte or a nonaqueous electrolyte, a nonaqueous electrolyte is preferred because a higher voltage can be set. As for the aqueous electrolyte, for example, potassium hydroxide may be used as the electrolyte. Examples of the nonaqueous electrolyte include a large number of ionic liquids constituted by combinations of a cation and an anion. Examples of the cation include lower aliphatic quaternary ammonium, lower aliphatic quaternary phosphonium, and imidazolinium. Examples of the anion include metal chloride ions, metal fluoride ions, and imide compounds such as bis(fluorosulfonyl)imide. Examples of the electrolyte solvent include polar aprotic organic solvents: specifically, ethylene carbonate, diethyl carbonate, dimethyl carbonate, propylene carbonate, γ-butyrolactone, and sulfolane. Examples of supporting electrolytes in the nonaqueous electrolyte include lithium tetrafluoroborate, lithium hexafluorophosphate, and imide salts.

### (Electrode for Molten Salt Battery)

The aluminum porous body can also be used as an electrode material for a molten salt battery. When the aluminum porous body is used as a positive electrode material, a metal compound allowing intercalation of cations of the molten salt serving as the electrolyte, that is, sodium chromite (NaCrO₂), titanium disulfide (TiS₂), or the like is used as the active material. The active material is used in conjunction with a conductive aid and a binder. Examples of the conductive aid include acetylene black. Examples of the binder include polytetrafluoroethylene (PTFE). When sodium chromate is used as the active material and acetylene black is used as the conductive aid, PTFE can more strongly bond the active material and the conductive aid, which is preferred.

The aluminum porous body can also be used as a negative electrode material for a molten salt battery. When the aluminum porous body is used as a negative electrode material, examples of the active material include elemental sodium, alloys between sodium and other metals, and carbon. Since sodium has a melting point of about 98° C. and this metal softens with a temperature increase, an alloy of sodium and another metal (Si, Sn, In, or the like) is preferred. In particular, an alloy between sodium and Sn is preferred because of ease of handling. Sodium or a sodium alloy can be made to adhere to the surface of the aluminum porous body by electrolytic plating, hot dipping, or the like. Alternatively, after sodium and a metal (Si or the like) that is to form an alloy with sodium are made to adhere to the aluminum porous body by plating or the like, the sodium alloy can be formed by charging in a molten salt battery.

FIG. 10 is a schematic sectional view of a molten salt battery serving as an example, the molten salt battery including the above-described battery electrode material. In the molten salt battery, the following components are contained in a case 127: a positive electrode 121 in which a positive electrode active material is carried on the surface of an aluminum skeleton of an aluminum porous body; a negative electrode 122 in which a negative electrode active material is carried on the surface of an aluminum skeleton of an aluminum porous body; and a separator 123 impregnated with a molten salt serving as an electrolyte. A pressing member 126 constituted by a presser plate 124 and a spring 125 pressing the presser plate is disposed between the upper surface of the case 127 and the negative electrode. Even when the volumes of the positive electrode 121, the negative electrode 122, and the separator 123 vary, the pressing member uniformly presses these components so that these components are in contact with one another. The collector (aluminum porous body) of the positive electrode 121 and the collector (aluminum porous body) of the negative electrode 122 are respectively connected to a positive electrode terminal 128 and a negative electrode terminal 129 through lead wires 130.

The molten salt serving as the electrolyte may be selected from various inorganic salts and organic salts that melt at the operation temperature. The cation of the molten salt may be one or more selected from alkali metals including lithium (Li), sodium (Na), potassium (K), rubidium (Rb), and cesium (Cs) and alkaline earth metals including beryllium (Be), magnesium (Mg), calcium (Ca), strontium (Sr), and barium (Ba).

To decrease the melting point of the molten salt, two or more salts are preferably used in combination.

For example, when potassium bis(fluorosulfonyl)amide <K—N(SO₂F)₂; KFSA> and sodium bis(fluorosulfonyl)amide <Na—N(SO₂F)₂; NaFSA> are used in combination, the operation temperature of the battery can be made 90° C. or less.

The molten salt is used such that a separator is impregnated therewith. The separator is configured to prevent the positive electrode and the negative electrode from coming into contact with each other. The separator may be formed of, for example, glass nonwoven fabric or a porous resin porous body. The positive electrode, the negative electrode, and the separator impregnated with the molten salt are stacked and contained in a case, and used as a battery.

### EXAMPLES

Hereinafter, the present invention will be specifically described with reference to Example and Comparative example.

### Example

### Formation of Conductive Layer

As a urethane resin porous body, a polyurethane foam having a porosity of 95%, about 50 pores (cell number) per inch, a pore diameter of about 550 μm, and a thickness of 1 mm was prepared. This polyurethane foam was cut so as to have dimensions of 100 mm×30 mm. An aluminum film having a coating weight of 10 g/m² was formed by sputtering on the surface of the polyurethane foam to form a conductive layer.

### Molten Salt Plating

As a plating bath for molten salt plating, a molten salt aluminum plating bath (EMIC:AlCl₃=1:2) at 60° C. was prepared.

Aluminum plates (material: A1050) were immersed as negative and positive electrodes in the plating bath and dummy plating was performed at a current density of 2 A/dm² for 3 hours.

Subsequently, the polyurethane foam that was obtained above and had the conductive layer thereon was set as works in a jig having a power feeding function, placed in a glove box having an argon atmosphere and a low water content (dew point: −30° C. or less), and immersed in the molten salt aluminum plating bath at 60° C.

The jig in which the works were set was connected to the negative electrode side of a rectifier and the aluminum plate (purity: 99.9% by mass) serving as the counter electrode was connected to the positive electrode side of the rectifier. A direct current at a current density of 3.6 A/dm² was applied for 90 minutes to perform plating. Stirring was performed with a rotor composed of Teflon (registered trademark) as a stirrer at 300 rpm. The current density was calculated in terms of the apparent area of the polyurethane foam.

The jig holding the works thereon was taken out and left above the plating bath for 2 minutes for draining. After that, 1 L of xylene was placed in a container having a cock at the bottom thereof. The works were immersed in this container for 1 minute to wash off the plating solution adhering to the works. The works were detached from the jig and then additionally washed in a washing container containing xylene. This xylene used at this time was collected and added to the xylene used in the immersion process; the total amount was 1.5 L. The works washed with xylene were taken out from the glove box and dried with hot air. As a result, an aluminum structure having an aluminum film with a coating weight of 150 g/m² was obtained.

### (Thermal Decomposition of Resin)

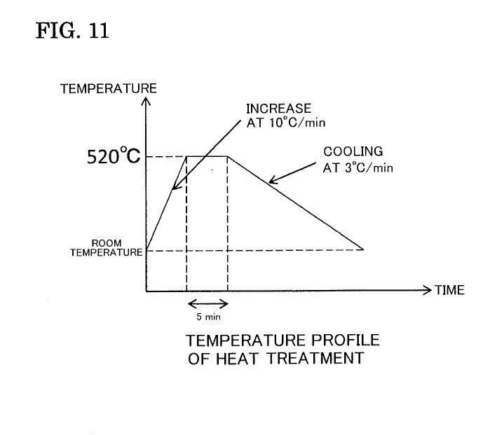

The aluminum structure obtained above was placed in a furnace at room temperature, heated at a heating rate of 10° C./min, and held at 520° C. for 5 minutes. The heating with the furnace was then stopped and air cooling (cooling rate: 3° C./min) was performed to provide an aluminum porous body. The heat treatment profile for the thermal decomposition is illustrated in FIG. 11.

The aluminum porous body obtained was dissolved in aqua regia and measured with an inductively-coupled plasma (ICP) emission spectrometer. As a result, the aluminum purity was found to be 99.9% by mass or more. Another measurement with a scanning X-ray photoelectron spectrometer (ULVAC-PHI QuanteraSXM) revealed that the oxide film had a thickness of 90 nm. Another measurement by an infrared absorption method after combustion in a high-frequency induction furnace according to JIS-G1211 revealed that the carbon content was 0.82 g/m².

The analysis values of components of the aluminum porous body obtained are described in Table 1 together with the analysis values of a commercially available aluminum (A1050).

A tab lead constituted by an aluminum foil was spot welded to the aluminum porous body obtained and the welding state was good.

TABLE I

| | Component element | | | | | | | |
|---|---|---|---|---|---|---|---|---|
| | Fe | Si | Cu | Mn | Mg | Zn | Ti | Al |
| | (mass %) | (mass %) | (mass %) | (mass %) | (mass %) | (mass %) | (mass %) | (mass %) |
| Al porous | 0.003 | 0.004 | 0.004 | Undetected | Undetected | Undetected | Undetected | 99.90 or |
| body | | | | | | | | more |
| A1050 | 0.04 | 0.25 | 0.05 | 0.05 | 0.05 | 0.05 | 0.03 | 99.00 or |
| | | | | | | | | more |

### Comparative Example 1

An aluminum porous body was obtained as in EXAMPLE 1 except that the dummy plating was not performed and aluminum (A1050) having a purity of 99% by mass was used as the positive electrode. As in EXAMPLE 1, this aluminum porous body was evaluated in terms of the purity of the aluminum porous body and the thickness of the oxide film. As a result, the aluminum purity was found to be 99.0% by mass and the thickness of the oxide film was found to be 200 nm.

### Reference Example 1

The aluminum structure obtained in EXAMPLE 1 was immersed in LiCl-KCl eutectic molten salt at 500° C. and a negative potential of −1 V was applied for 30 minutes. Bubbles due to the decomposition reaction of polyurethane were generated in the molten salt. After that, the body was cooled to room temperature in the air and then washed with water to remove the molten salt to provide an aluminum porous body from which the resin had been removed. The surface of the aluminum porous body obtained was measured with a scanning X-ray photoelectron spectrometer (ULVAC-PHI QuanteraSXM). As a result, the oxide film was found to have a thickness of 80 nm.

Thus, it has been demonstrated that, even by a simple process of thermally decomposing a urethane resin in the air, an aluminum porous body can be provided that has an oxide film having a thickness similar to that in a process of thermally decomposing a urethane resin in a molten salt.

Although the present invention has been described so far on the basis of the embodiments, the present invention is not limited to these embodiments. The embodiments can be modified in various manners within the scope identical to the present invention and the scope of its equivalence.

### INDUSTRIAL APPLICABILITY

According to the present invention, a resin can be stably continuously removed through thermal decomposition from a sheet-shaped aluminum structure prepared by forming an aluminum film on the surface of a urethane resin porous body. Therefore, the present invention can provide a method for producing an aluminum porous body that can be used in wide-ranging applications where characteristics of aluminum are utilized, such as various filters, catalyst carriers, and battery electrodes; and the aluminum porous body.

### REFERENCE SIGNS LIST

1 resin porous body

2 conductive layer

3 aluminum plating layer

21a, 21b plating container

22 strip-shaped resin

23, 28 plating bath

24 cylindrical electrode

25, 27 positive electrode

26 electrode roller

60 lithium battery

61 positive electrode

62 negative electrode

63 solid electrolyte layer (SE layer)

64 positive electrode layer (positive electrode body)

65 positive electrode collector

66 negative electrode layer

67 negative electrode collector

121 positive electrode

122 negative electrode

123 separator

124 presser plate

125 spring

126 pressing member

127 case

128 positive electrode terminal

129 negative electrode terminal

130 lead wire

141 polarizable electrode

142 separator

143 organic electrolyte

144 lead wire

145 case

1. A method for producing an aluminum porous body, comprising: forming an aluminum film having a purity of 99.9% by mass or more on a surface of a urethane resin porous body having a three-dimensional network structure to provide an aluminum structure including the urethane resin porous body and the aluminum film; and subjecting the aluminum structure to a heat treatment at 370° C. or more and less than 660° C. in the air to remove urethane resin and to provide an aluminum porous body.

2. The method for producing an aluminum porous body according to claim 1, wherein the heat treatment is performed at 370° C. or more and 550° C. or less.

3. The method for producing an aluminum porous body according to claim 1, wherein the urethane resin porous body is a polyurethane foam.

4. The method for producing an aluminum porous body according to claim 1, wherein the aluminum film is formed by electroplating in a molten salt bath.

5. The method for producing an aluminum porous body according to claim 4, wherein, before the step of forming the aluminum film on the surface of the urethane resin porous body, a step of removing metal ions in molten salt by electrolysis is performed.

6. An aluminum porous body having a three-dimensional network structure and an aluminum purity of 99.9% by mass or more.

7. The aluminum porous body according to claim 6, wherein an aluminum oxide film having a thickness of less than 200 nm is present in an outer surface of an aluminum skeleton forming the three-dimensional network structure.

8. The aluminum porous body according to claim 6, wherein metallic aluminum is present in an outermost surface of an aluminum skeleton forming the three-dimensional network structure.

9. The aluminum porous body according to claim 6, having a carbon content of less than 1 g/m².
